(19) United States
(12) Patent Application Publication
(10) Pub. No.: US 2004/0031628 A1
(43) Pub. Date: Feb. 19, 2004

(54) Method to control at least one movement of an industrial truck

(76) Inventors: Hans-Jorg Schiebel, Kusterdingen (DE); Michael Meinhardt, Reutlingen (DE); Ralf Mebert, Nurtingen (DE)

Correspondence Address: William H. Logsdon, WEBB ZIESENHEIM LOGSDON ORKIN & HANSON, P.C., 700 Koppers Building, 436 Seventh Avenue, Pittsburgh, PA, 15219-1818, US

(21) Appl. No.: 10/459,404

(22) Filed: Jun. 11, 2003

(30) Foreign Application Priority Data
Jun. 14, 2002 (DE) 102 26 599.2

(51) Int. Cl. G01G 19/02; G01G 19/52

(52) U.S. Cl. 177/146

(57) ABSTRACT

A method is provided to control at least one movement of an industrial truck. The method includes determining the lifting height of load holding means (5), determining the weight of a lifted load, calculatiing of the position of the overall center of gravity (S) of the industrial truck, calculating a variable which is a function of the stability of the industrial truck in at least one direction, and determining the allowable scope of the movement of the industrial truck. The overall center of gravity (S) and/or the stability of the industrial truck can be calculated taking into consideration a potential elastic deformation of a lifting platform (6) of the industrial truck.

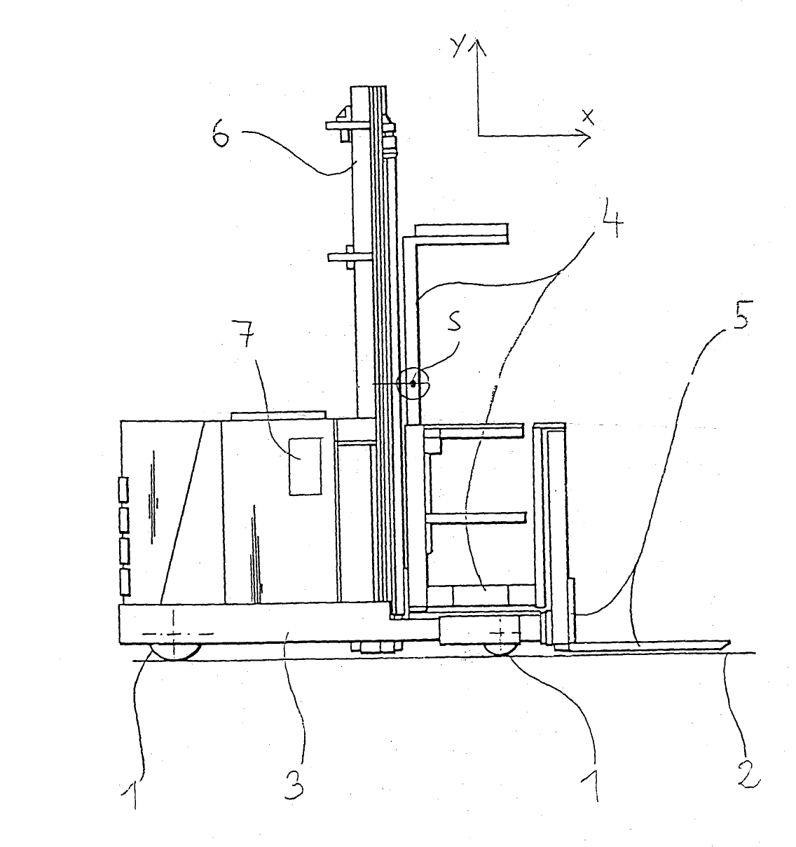

### CROSS-REFERENCE TO RELATED APPLICATION

This application corresponds to German Application No. 102 26 599.2, filed Jun. 14, 2002, which is herein incorporated by reference in its entirety.

### BACKGROUND OF THE INVENTION

1. Field of the Invention

This invention relates to a method to control at least one movement of an industrial truck.

2. Technical Considerations

Certain types of industrial trucks, in particular high shelf stackers and high lift order pickers, are designed to travel with a raised load. Special technical requirements apply to these industrial trucks. For example, depending on the current conditions under which the industrial truck is operating, the various movements of the industrial truck, for example the speed of travel or the lifting height of the industrial truck, must be restricted to allowable values. The allowable maximum speed of travel varies with the lifting height and the weight of the load being lifted. On known industrial trucks, the speed of travel and the braking acceleration are adjusted as a function of the current lifting height. Generally, the lifting height is determined by means of position switches, which can be used to determine in what portion of the range of the total lifting height the load holding means are currently located. The known art also describes the continuous determination of the lifting height by means of measurement transmitters. On these known systems, the maximum speed of travel is defined independently of the weight of the raised load. One disadvantage of such control methods is that additional variables that also affect the stability of the industrial truck are not taken into consideration in the determination of the maximum speed of travel. For this reason, the maximum speed of travel is determined to allow a significant safety margin, which frequently restricts the efficiency of the handling operations of the industrial truck beyond what is strictly necessary.

Therefore, it is an object of the invention to provide a method for controlling at least one movement of an industrial truck which, by taking into consideration all safety aspects, optimizes the movement of the industrial truck with regard to the handling efficiency of the industrial truck.

### SUMMARY OF THE INVENTION

The invention teaches a method for the control of at least one movement of an industrial truck that comprises one or more of the following steps:

a. determination of the lifting height of load holding means,

b. determination of the weight of a lifted load,

C. calculation of the position of the overall center of gravity of the industrial truck,

d. calculation of a variable which is a function of the stability of the industrial truck in at least one direction, and

e. determination of the allowable scope of the movement of the industrial truck based on one or more of the above steps.

The lifting height and the weight of the load can be measured continuously and steplessly by means of suitable conventional measurement transmitters. From these two measurement values, the position of the overall center of gravity of the industrial truck can be calculated. This calculation can include, among other things, the empty weight of the industrial truck, and the location of the center of gravity of the industrial truck. Starting from the position of the overall center of gravity of the industrial truck, the stability of the industrial truck can then be calculated, such as in the forward, backward and lateral direction. The measure of stability is a tilting in the corresponding direction that does not quite result in a tipping of the industrial truck. On that basis, the allowable scope of the movement of the industrial truck in the corresponding direction can be determined. The result of this calculation can be, for example, the allowable speed of travel, the allowable deceleration, or the allowable lifting height.

A particularly high degree of accuracy is achieved in the calculation of the position of the overall center of gravity and thus of the stability of the industrial truck if the calculation is made taking into consideration a potential elastic deformation of at least one component of the industrial truck. The picking up and lifting of a load results in elastic deformations in the force-transmitting parts of the industrial truck, which in turn influences the position of the overall center of gravity. Elastic deformation occurs, for example, in the vicinity of the pivoting load fork, of the lifting platform, of the vehicle chassis, or the tires. The inclusion of the elastic deformation in the calculation results in a significant improvement of the accuracy of the determination of the stability of the industrial truck.

It is particularly advantageous if the calculation of the overall center of gravity and the stability of the industrial truck takes into consideration a potential elastic deformation of a lifting platform of the industrial truck.

The method of the invention can be used particularly advantageously if the movement of the industrial truck, the allowable scope of which is being determined, is the lifting movement of load holding means. The lifting height of the load holding means and thus of the load on the load holding means are significant factors in the calculation of the risk that an industrial truck will tip over. When the tipping risk exceeds a certain predetermined level, any further upward movement of the load holding means can be prevented or slowed down.

A high degree of operational safety can be achieved by preventing an upward lifting movement (elevation) of the load holding means if the calculated stability in at least one direction is lower than the required stability in the same direction. Thus, any further reduction of the stability as a result of the elevation of the overall center of gravity of the industrial truck can be prevented. The required stability is thereby defined so that the stability specified according to the guidelines for the operation of such industrial trucks is guaranteed at all times during the operation of the industrial truck. An upward lifting movement is thereby prevented if the stability resulting from a further lifting of the load would drop below the level specified by the guidelines for the operation of the industrial truck.

The invention can likewise be used advantageously if the movement of the industrial truck, the allowable scope of which is being determined, is the speed of travel of the industrial truck in the forward and/or reverse direction. In particular, the maximum speed of travel of the industrial truck can be reduced as a function of the position of the overall center of gravity.

The allowable speed of travel in the forward and/or reverse direction can thereby be determined appropriately as a function of a physically possible braking acceleration of the industrial truck in the corresponding direction. The physically possible braking acceleration is a function of the perpendicular forces that act between the braked wheels and the road surface and the friction conditions. In this case, there can be different braking accelerations in the forward and reverse directions. The maximum speed of travel can thereby be defined so that the deceleration does not drop below a specified level.

With regard to the stability of the industrial truck, the allowable speed of travel in the forward and/or reverse direction can be determined as a function of an allowable braking acceleration of the industrial tuck in the corresponding direction. The braking acceleration is classified as allowable if sufficient stability of the industrial truck is guaranteed, i.e., if there is no danger that the industrial truck will tip over as a result of the inertial forces that occur during braking. The allowable speed of travel can then be set so that the required braking acceleration in the corresponding direction is achieved.

The allowable braking acceleration of the industrial truck can be determined as a function of the stability of the industrial truck, among other things. The stability and thus the risk that the industrial truck will tip over during a braking process is determined primarily by the position of the overall center of gravity. The more accurately the position of the overall center of gravity can be determined, the more accurately the variables that are a function of the stability of the industrial truck, and thus the allowable braking acceleration, can be determined.

The allowable speed of travel in the forward and/or reverse direction can also be determined as a function of a current steering angle of a steered wheel of the industrial truck. The allowable speed of travel can thereby be reduced as the steering angle increases.

On industrial trucks that are equipped with a device to move the load relative to a lifting platform, the allowable scope of these movements can also be determined with the method of the invention. A device of this type for the movement of the load can be formed, for example, by a pivoting load fork that comprises a lateral thrusting device, a pivoting device, and/or a supplemental lifting device. The allowable scope of these movements can be defined, for example, in the form of an allowable speed or an allowable acceleration.

The invention also provides an industrial truck with a control device for the performance of the method described above. The method can be stored in the control device in the form of conventional software. The allowable values for the movements of the industrial truck, i.e., the maximum lifting height, the allowable braking acceleration, and/or the maximum speed of travel, can thereby be determined during the operation of the industrial truck. After the actuation of the respective movement by the operator, the movement in question can be controlled by the control device, taking the determined allowable values into consideration.

The industrial truck can be configured so that it can travel with a raised load. These industrial trucks can travel at a considerable speed even with the load raised a significant distance off the ground. These industrial trucks are subject to special requirements regarding stability which are safely and reliably satisfied with the methods described herein and carried out by the control device.

These industrial trucks can be conventionally realized in the form of high shelf stackers or high shelf order pickers. In these industrial trucks, the driver's console is frequently elevated together with the load holding means.

### BRIEF DESCRIPTION OF THE DRAWING

Additional advantages and details of the invention are described below with reference to the exemplary embodiment which is schematically illustrated in the accompanying schematic drawing.

### DESCRIPTION OF THE PREFERRED EMBODIMENT

The figure shows an industrial truck of the invention realized in the form of a high shelf order picker, in a side view. The industrial truck is in contact with a roadway 2 by means of its wheels 1, which are mounted directly or indirectly on a vehicle chassis 3 which cannot be elevated. A driver's console 4 can be elevated together with a load holding means 5 fastened to the driver's console 4 along a telescoping lifting platform 6.

The industrial truck comprises a control device 7 for the control of the various movements of the industrial truck. These movements can be, for example, the speed of travel, the lifting movement, and/or a braking of the industrial truck. The allowable scope of these movements is determined as a function of the position of the overall center of gravity S of the industrial truck. The control device 7 can calculate the position of the overall center of gravity S in the x-direction and in the y-direction on the basis of the basic data of the industrial truck, the current lifting height of the load holding means, and the current weight of the load. The lifting height can be determined by means of a suitable lifting height sensor, the output signal of which is transmitted to the control device 7 in any conventional manner. The weight of the load can be measured, for example, by means of a dynamometer located on a load chain, the output signal line of which is also connected to the control device 7. For the determination of the position of the overall center of gravity S of the industrial truck, an elastic deformation of the lifting platform 6 as a result of the weight of the load can also be included, which significantly improves the accuracy of the calculation.

As a function of the position of the overall center of gravity S, any further lifting of the load holding means 5 can be prevented, for example, if the stability of the industrial truck would thereby be unacceptably adversely affected. Moreover, an allowable braking acceleration in both x-directions is determined, which is defined so that the industrial truck is also sufficiently stable during a braking process. Starting with the allowable braking acceleration, the maximum allowable speed of travel can be determined. The current steering angle of the industrial truck can be used as an additional factor for the determination of the maximum speed of travel. The maximum allowable speed of travel can be reduced as the steering angle increases.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A method to control at least one movement of an industrial truck, comprising:
determining a lifting height of a load holding means;
determining a weight of a lifted load;
calculating a position of an overall center of gravity of the industrial truck;
calculating a variable which is a function of the stability of the industrial truck in at least one direction; and
determining an allowable scope of at least one movement of the industrial truck.

2. The method as claimed in claim 1, wherein at least one of the stability and the position of the overall center of gravity of the industrial truck is calculated taking into consideration a potential elastic deformation of at least one component of the industrial truck.

3. The method as claimed in claim 1, wherein at least one of the stability and the position of the overall center of gravity of the industrial truck is calculated taking into consideration a potential elastic deformation of a lifting platform of the industrial truck.

4. The method as claimed in claim 1, wherein the at least one movement includes the lifting movement of the load holding means.

5. The method as claimed in claim 4, wherein elevation of the load holding means is prevented if the calculated stability in at least one direction is less than a required stability in the same direction.

6. The method as claimed in claim 1, wherein the at least one movement includes the speed of travel of the industrial truck in a forward and/or reverse direction.

7. The method as claimed in claim 6, wherein an allowable speed of travel in the forward and/or reverse direction is determined as a function of a physically possible braking acceleration of the industrial truck in the corresponding direction.

8. The method as claimed in claim 6, wherein an allowable speed of travel in the forward and/or reverse direction is determined as a function of an allowable braking acceleration of the industrial truck in the corresponding direction.

9. The method as claimed in claim 6, wherein the allowable braking acceleration of the industrial truck is determined as a function of the position of the stability of the industrial truck.

10. The method as claimed in claim 6, wherein the allowable speed of travel in the forward and/or reverse direction is determined as a function of a current steering angle of a steered wheel of the industrial truck.

11. The method as claimed in claim 1, wherein the at least one movement includes a movement of the load holding means relative to a lifting platform of the industrial truck.

12. An industrial truck including a control device for the performance of the method as claimed in claim 1.

13. The industrial truck as claimed in claim 12, wherein the industrial truck is configured so that it can travel with a raised load.

14. The industrial truck as claimed in claim 12, wherein the industrial truck is a high shelf stacker or a high shelf order picker.

15. The method as claimed in claim 2, wherein at least one of the stability and the position of the overall center of gravity of the industrial truck is calculated taking into consideration a potential elastic deformation of a lifting platform of the industrial truck.

16. The method as claimed in claim 7, wherein an allowable speed of travel in the forward and/or reverse direction is determined as a function of an allowable braking acceleration of the industrial truck in the corresponding direction.

17. The method as claimed in claim 7, wherein the allowable braking acceleration of the industrial truck is determined as a function of the position of the stability of the industrial truck.

18. The method as claimed in claim 7, wherein the allowable speed of travel in the forward and/or reverse direction is determined as a function of a current steering angle of a steered wheel of the industrial truck.
